(19) United States
(12) Patent Application Publication
(10) Pub. No.: US 2016/0048714 A1
(43) Pub. Date: Feb. 18, 2016

(54) DATA COLLECTION SCHEME

(71) Applicant: EMPIRE TECHNOLOGY DEVELOPMENT LLC, Wilmington, DE (US)

(72) Inventors: Noriaki MITSUNAGA, Yao-shi (JP); Tsutomu MIYASATO, Nara-shi (JP); Rieko KADOBAYASHI, Kizugawa-shi (JP)

(21) Appl. No.: 14/779,076

(22) PCT Filed: Dec. 27, 2013
(86) PCT No.: PCT/US13/77947

§ 371 Date: Sep. 22, 2015

(51) Int. Cl. G06K 7/10; H04N 5/77; H04N 5/232; G06F 17/30

(52) U.S. Cl. CPC G06K 7/10792; G06F 17/30265; G06F 17/30817; G06K 7/10722; G06K 7/10861; G06K 7/1093; H04N 5/77; H04N 5/23203

(57) ABSTRACT

Technologies are generally described for a data collection scheme. In some examples, a method performed under control of an electronic device may include receiving a data submission request from a posting device; determining that data corresponding to the data submission request is stored in a memory of the electronic device; and notifying a user of the electronic device of the data submission request.

### BACKGROUND

Demand for video recording devices for vehicles has been significantly growing over the past few years. Such video recording devices are usually fitted by dashboards or around rear-view mirrors to capture the surroundings ahead of vehicles. More and more drivers tend to install the video recording devices in their vehicles so that, as the video recording devices record footage in high definition, they can provide evidence of who is at fault and easily report accidents to police and/or insurance companies.

### SUMMARY

In an example, a method performed under control of an electronic device may include receiving a data submission request from a posting device; determining that data corresponding to the data submission request is stored in a memory of the electronic device; and notifying a user of the electronic device of the data submission request.

In another example, an electronic device may include a camera configured to capture a data submission request displayed by a posting device; a memory configured to store one or more images or videos captured by the camera; a determination unit configured to determine that the memory stores one or more images or videos corresponding to information included in the data submission request; and a notification unit configured to notify a user of a positive result of the determining.

In yet another example, a computer-readable storage medium may store thereon computer-executable instructions that, in response to execution, cause an electronic device to perform operations, including receiving a data submission request from a posting device; determining that a memory of the electronic device stores data corresponding to the data submission request; and notifying a user of the electronic device of the data submission request.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment in which a user drives a vehicle around an event, which is recorded by an electronic device, arranged in accordance with at least some embodiments described herein;

FIG. 2 schematically shows an illustrative example of an environment in which an electronic device installed in a vehicle receives, from a posting device, a data submission request that instructs a user to transmit data corresponding to the data submission request to a source of the data submission request, arranged in accordance with at least some embodiments described herein;

FIG. 3 schematically shows a block diagram of an example architecture of an electronic device that implements at least portions of a data collection scheme, arranged in accordance with at least some embodiments described herein;

FIG. 4 shows a schematic block diagram illustrating another example architecture of a electronic device that implements at least portions of a data collection scheme, arranged in accordance with at least some embodiments described herein;

FIG. 5 shows a schematic block diagram illustrating an example architecture of a data collection manager that implements at least portions of a data collection scheme, arranged in accordance with at least some embodiments described herein;

FIG. 6 schematically shows an example processing flow for execution of at least portions of a data collection scheme, arranged in accordance with at least some embodiments described herein;

FIG. 7 illustrates an example computer program product that may be utilized to implement at least portions of a data collection scheme, arranged in accordance with at least some embodiments described herein; and

FIG. 8 shows a schematic block diagram illustrating an example computing system that can be utilized to implement at least portions of a data collection scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, may be arranged, substituted, combined, separated, and designed in a wide variety of different configurations, all of which are explicitly contemplated herein.

This disclosure is generally drawn, inter alia, to methods, apparatus, systems, devices and computer program products related to data collection. Further, technologies are herein generally described for collecting image or video data recorded in an electronic device that is installed in a vehicle.

In some examples, an electronic device having a digital image and/or video recording functionality may be installed on at least one portion of a vehicle. The vehicle may happen to pass by an event (such as, for example, a car accident), and at that moment, the electronic device may capture image data or video data of the event. Further, the electronic device may store, in its memory, the captured data together with a time information thereof. If the electronic device has a localization functionality (such as, for example, a GPS receiver), the electronic device may also store a location information of the captured data.

After the event, one that collects any data relating to the event may transmit a data submission request including at least one of a time range or a geographical range pertaining to the event. The data submission request may be transmitted via a posting device, which may be placed around the location in which the event occurred or any other places of a lot of traffic. In some examples, the data submission request may be included in a code (such as, for example, a Quick Response Code (QR code)), which may be displayed by the posting device (such as, for example, a billboard). Alternatively or additionally, the data submission request may be included in an optical tag that is displayed by the posting device or a radio signal that is transmitted from the posting device.

When the vehicle goes in the vicinity of the posting device, the electronic device may receive the data submission request. As a non-limiting example, when the posting device is displaying a QR code that conveys the data submission request including the time range and the geographical range pertaining to the event, the electronic device may capture the QR code with its camera and decode the QR code to obtain the time range and the geographical range. Then, the electronic device may search the memory for data based at least in part on the time range and the geographical range to determine whether data corresponding to the data submission request is stored in the memory.

When the determining result is positive, the electronic device may notify a user of the electronic device of the data submission request. In some examples, the electronic device may display a message and/or play a sound to instruct the user to transmit the data corresponding to the data submission request to a source of the data submission request. Alternatively or additionally, the electronic device may transmit the data to the source of the data submission request when the electronic device is equipped with a data transmission functionality.

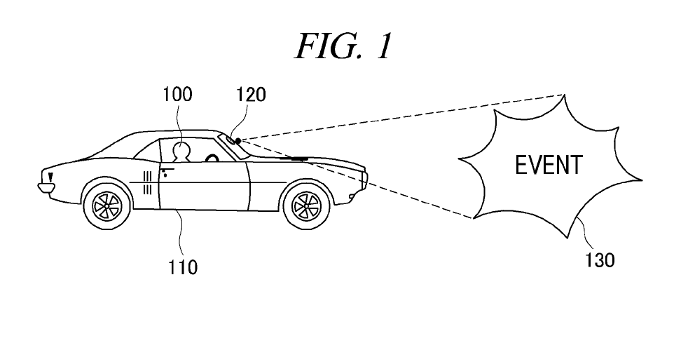

FIG. 1 schematically shows an illustrative example of an environment in which a user 100 drives a vehicle 110 around an event 130, which is recorded by an electronic device 120, arranged in accordance with at least some embodiments described herein.

As depicted in FIG. 1, user 100 may be a driver of vehicle 110, and vehicle 110 may be any type of transportation including a four-wheeled vehicle such as, for example, a bus, a truck, a sedan, etc., a tricycle, a motorcycle, or even a train. Further, electronic device 120 may be installed in a portion of vehicle 110. By way of example, but not limitation, electronic device 120 may be a separate device that is installed on vehicle 110 by user 100 or a built-in device of vehicle 110. Although FIG. 1 depicts as electronic device 120 is installed around a front window of vehicle 110 so that electronic device 120 may record a front view of vehicle 110, the position of electronic device 120 is not limited thereto.

In some embodiments, electronic device 120 may be configured to record one or more image and/or video data of the surroundings ahead of vehicle 110. As depicted in FIG. 1, electronic device 120 may record image and/or video data of event 130 that occurs in front of vehicle 110. By way of example, but not limitation, event 130 may be traffic accident, injury, kidnapping, murder, disappearance, suspected arson, etc.

In some embodiments, electronic device 120 may be configured to capture the image and/or video data of event 130 using a camera and store the captured data in a memory. By way of example, but not limitation, the camera may include an internal camera of electronic device 120 or an external camera that is operatively connected to electronic device 120 via a wired or wireless connection. The memory may be an internal memory of electronic device 120 or a remote memory, such as, for example, a cloud data center, to which electronic device 120 may transmit the captured data via a wireless network.

In some embodiments, electronic device 120 may be configured to store time information of the captured data in the memory. By way of example, but not limitation, the time information may be generated by electronic device 120 or an external device including, for example, an external clock or a network clock. Further, electronic device 120 may be configured to store location information of the captured data in the memory. The location information may be obtained by a localization unit, which may be an internal or external unit of electronic device 120, such as, for example, a GPS receiver.

By way of example, electronic device 120 may include a car driving recorder which has at least some of the above-described functionalities, but not limited thereto. Any types of devices that can be installed on vehicle 110 to perform at least some of the above-described functionalities, such as, for example, a smartphone, a tablet, a personal digital assistant, a mobile phone, a phablet, etc., can be electronic device 120.

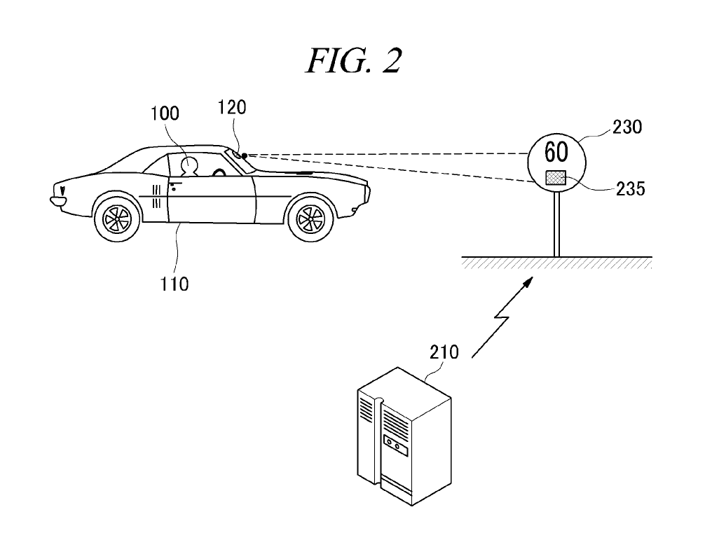

FIG. 2 schematically shows an illustrative example of an environment in which electronic device 120 installed in vehicle 110 receives, from a posting device 230, a data submission request that instructs user 100 to transmit data corresponding to the data submission request to a source 210 of the data submission request, arranged in accordance with at least some embodiments described herein.

In some embodiments, after event 130 occurred, one who is associated with event 130 (such as, for example, a person directly involved in event 130, police or an insurance company) may require data relating to event 130 (such as, for example, image data or video data capturing event 130). As depicted in FIG. 2, source 210 may transmit a data transmission request (based on a request from the one who is associated with event 130) to posting device 230.

Source 210 may be a computing device (such as, for example, a server) under control of the one who is associated with event 130. By way of example, but not limitation, source 210 may generate the data submission request based on the request from the one who is associated with event 130. Further, source 210 may send the data submission request to posting device 230 via a wired or wireless network.

In some embodiments, the data submission request may include at least one of a time range or a geographical range pertaining to event 130. Further, the data submission request may include information about source 210 and/or the one who is associated with event 130 (such as, for example, an e-mail address, a web address, a street address, etc.) so that one who is notified of the data submission request can send data corresponding to the data submission request to source 210 and/or the one who is associated with event 130.

By way of example, but not limitation, the data submission request may be included in a code (such as, for example, a QR code, a bar code, etc.), a radio signal or an optical tag. That is, source 210 may be configured to generate the code, the radio signal, or the optical tag by encoding the data submission request and transmit the code, the radio signal or the optical tag to posting device 230. However, in the below descriptions relating to FIG. 2, it is assumed that the data submission request is included in a code and source 210 may transmit the code to posting device 230 so that posting device 230 may display the code.

Posting device 230 may be configured to receive the code including the data submission request and display the code in a display area 235. Although posting device 230 in FIG. 2 is shown as a traffic sign, any other article, device or apparatus (such as, for example, a billboard) that may receive and display the code may become posting device 230. Alternatively or additionally, the one who is associated with event 130 may attach the code in a printed form on posting device 230. In such cases, posting device 230 may not require a communication functionality and/or a display functionality and may include, but not limited thereto, a side wall of a bus or a train, a traffic sign, or an outer wall of a building.

In some embodiments, electronic device 120 may be configured to capture the code displayed on display area 235 and decode the captured code to obtain the data submission request including the at least one of the time range or the geographical range pertaining to event 130. Further, electronic device 120 may be configured to determine whether the memory stores one or more image or video data corresponding to the at least one of the time range or the geographical range by searching the memory.

In other embodiments, the data transmission request may be included in an optical tag (such as, for example, a infrared tag, a visible ray tag, etc.). In such cases, electronic device 120 may include an optical tag reader configured to capture the optical tag, which may be displayed on display area 235 of posting device 230, and decipher the at least one of the time range or the geographical range included in the optical tag. In yet other embodiments, the data submission request may be included in a radio signal. In such cases, posting device 230 may include a transmitter configured to transmit the radio signal, and electronic device 120 may include a receiver configured to receive the radio signal and a decoder configured to decipher the at least one of the time range or the geographical range included in the radio signal.

In some examples, when electronic device 120 determines that the data corresponding to the data submission request is stored in the memory, electronic device 120 may be configured to notify user 100 of the data submission request. By way of example, but not limitations, electronic device 120 may include a speaker playing a sound to instruct user 100 to transmit the data in accordance with the data submission request. Alternatively or additionally, electronic device 120 may include a display configured to display a message to instruct user 100 to transmit the data in accordance with the data submission request. The sound and/or message may indicate information to which the data should be transmitted, such as, for example, an e-mail address and/or a web address of source 210, or a street address of the one who is associated with event 130, so that user 100 may directly submit the data corresponding to the data submission request to a destination.

In some embodiments, alternatively or additionally, electronic device 120 may include a transmitter configured to transmit the data corresponding to the data submission request to the destination. In such embodiments, electronic device 120 may be further configured to ask user 100 whether or not to transmit the requested data and, upon receiving an approval from user 100, transmit the data to the destination designated in the data submission request.

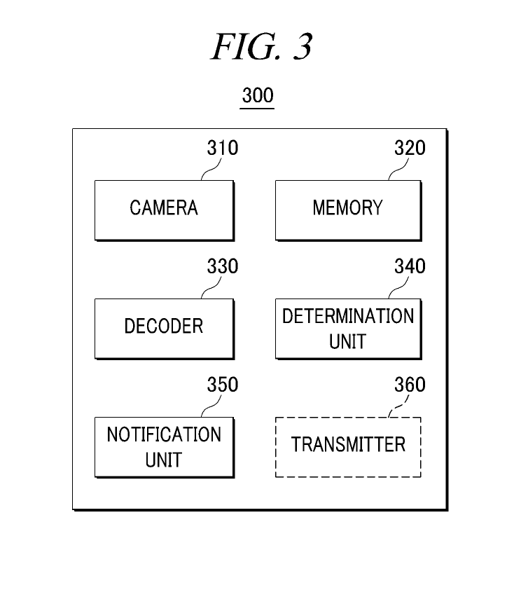

FIG. 3 schematically shows a block diagram of an example architecture of an electronic device 300 that implements at least portions of a data collection scheme, arranged in accordance with at least some embodiments described herein.

As depicted in FIG. 3, electronic device 300 may include a camera 310, a memory 320, a decoder 330, a determination unit 340 and a notification unit 350. In some examples, alternatively or additionally, electronic device 300 may further include a transmitter 360. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Camera 310 may be configured to capture image data and/or video data. In some embodiments, camera 310 may capture image data and/or video data of event 130. Further, camera 310 may be configured to capture a data submission request displayed by a posting device, such as posting device 230. By way of example, but not limitation, the data submission request may be included in a code (such as, for example, a QR code, a bar code, etc.).

Memory 320 may be configured to store the captured data therein. In some embodiments, memory 320 may store the image data and/or video data of the event captured by camera 310. In some embodiments, memory 320 may store the captured data with at least one of time information and location information thereof. By way of example, but not limitation, the time information may be generated by electronic device 300 or an external device including, for example, an external clock or a network clock. The location information may be obtained by a localization unit, which may be an internal or external unit of electronic device 300, such as, for example, a GPS receiver.

Decoder 330 may be configured to decode the code from the posting device to obtain the data submission request including the at least one of the time range or the geographical range pertaining to the event, such as event 130. Although FIG. 3 is shown that camera 310 captures the code and decoder 330 decodes the code to obtain the data submission request as described above, in other embodiments, the data transmission request may be included in an optical tag (such as, for example, an infrared tag, a visible ray tag, etc.). In such cases, electronic device 300 may further include an optical tag reader configured to capture the optical tag, which may be displayed by the posting device, and decipher the at least one of the time range or the geographical range included in the optical tag. In yet other embodiments, the data submission request may be included in a radio signal, and in such cases, electronic device 300 may further include a receiver configured to receive the radio signal and a decoder configured to decipher the at least one of the time range or the geographical range included in the radio signal.

Determination unit 340 may be configured to determine whether memory 320 stores the data corresponding to the data submission request. In some embodiments, determination unit 340 may be configured to search memory 320 based at least on the at least one of the time range or the geographical range included in the data submission request which is obtained by decoder 330. Based on the results of the searching, determination unit 340 may determine whether memory 320 stores the image data and/or video data corresponding to the data submission request.

Notification unit 350 may be configured to notify a user of the data submission request. In some embodiments, when determination unit 340 determines that memory 320 stores the data corresponding to the data submission request, notification unit 350 may notify the user of positive determination result by determination unit 340. By way of example, but not limitation, notification unit 350 may generate a sound to instruct the user to transmit the data in accordance with the data submission request and play the sound on a speaker (not shown). Alternatively or additionally, notification unit 350 may generate a message to instruct the user to transmit the data in accordance with the data submission request and display the message on a display (not shown). The sound and/or message may indicate information to which the data should be transmitted, for example, an e-mail address and/or a web address of a source of the data submission request, or a street address of one who is associated with the event, so that the user may directly submit the data corresponding to the data submission request to a destination.

In some embodiments, alternatively or additionally, electronic device 300 may further include transmitter 360. Transmitter 360 may transmit the data corresponding to the data submission request the destination designated in the data submission request. In such cases, notification unit 350 may be further configured to ask the user whether or not to transmit the requested data. Upon receiving an approval from the user, transmitter 360 may transmit the data to the destination.

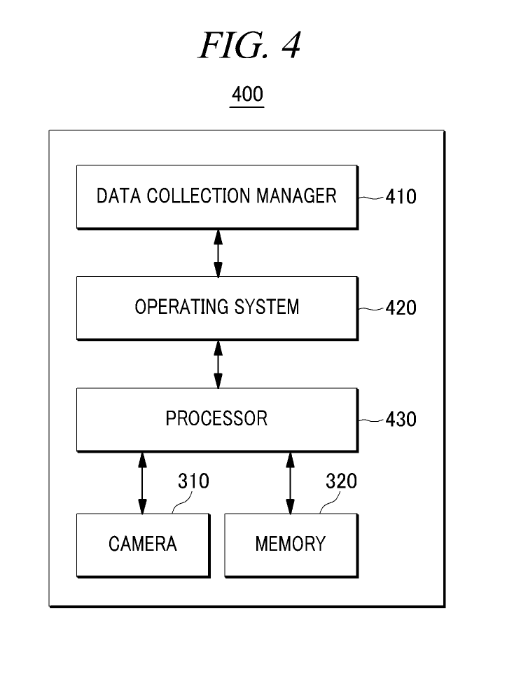

FIG. 4 shows a schematic block diagram illustrating another example architecture of an electronic device 400 that implements at least portions of a data collection scheme, arranged in accordance with at least some embodiments described herein. Reference may be made to the embodiments depicted and described with reference to FIGS. 1-3.

As depicted, electronic device 400 may include a data collection manager 410, an operating system 420, a processor 430, a camera 310 and a memory 320. In some embodiments, data collection manager 410 may be at least a part of an application installed in electronic device 400. In such cases, when camera 310 captures a data submission requests, for example, in form of a code, data collection manager 410 may decode the code; determine whether data corresponding to the data submission request are stored in memory 320; and notifying a user of the data submission request.

Data collection manager 410 may be configured to operate on operating system 420 such that the data collection scheme, as described herein, may be implemented. Operating system 420 may allow data collection manager 410 to manipulate processor 430 to implement the data collection scheme as described herein.

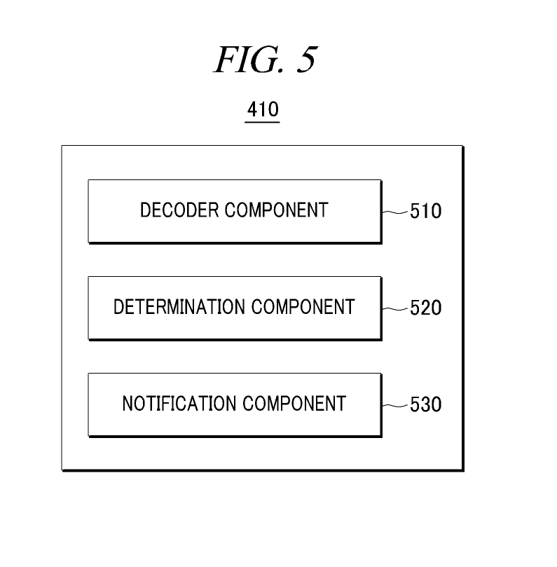

FIG. 5 shows a schematic block diagram illustrating an example architecture of data collection manager 410 that implements at least portions of a data collection scheme, arranged in accordance with at least some embodiments described herein. Reference may be made to the embodiments depicted and described with reference to FIGS. 1-4.

As depicted, data collection manager 410 may include a decoder component 510, a determination component 520 and a notification component 530.

Decoder component 510 may be configure to decode the code captured by camera 310 to obtain the data submission request including at least one of a time period or a geographical period included therein. Determination unit 520 may be configured to determine whether the data corresponding to the data submission request is stored in memory 320. Notification component 530 may be configured to notify a user of the data submission request. In some examples, if determination unit 520 determines that the data corresponding to the data submission request is stored in memory 320, notification component 530 may notify the user that the data corresponding to the data submission request is stored in memory 320 and instruct the user to transmit the data in accordance with the data submission request.

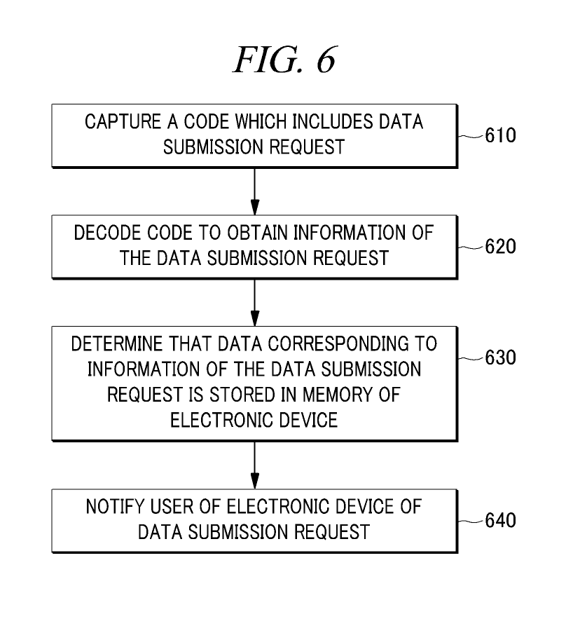

FIG. 6 schematically shows an example processing flow for execution of at least portions of a data collection scheme, arranged in accordance with at least some embodiments described herein.

Process 600 may be implemented in an electronic device such as electronic device 300 which may be installed in a vehicle such as vehicle 110. Process 600 may also be implemented by computer programs or program modules that may be adapted to provide data collection scheme. Thus, reference may be made to the embodiments depicted and described with reference to FIGS. 1-5. Process 600 may include one or more operations, actions, or functions as illustrated by one or more blocks 610, 620, 630 and/or 640. Although illustrated as discrete blocks, various blocks may be divided into additional blocks, combined into fewer blocks, or eliminated, depending on the desired implementation. Processing may begin at block 610.

At block 610 (Capture a Code which includes Data Submission Request), camera 310 may capture a code, which includes the data submission request, displayed by a posting device. By way of example, but not limitation, the code may be a QR code or a bar code. In other embodiments, the data submission request may be included in an optical tag, such as infrared tag or a radio signal. Processing may continue from block 610 to block 620.

At block 620 (Decode Code to Obtain Data Submission Request), decoder 330 may decode a code to obtain the data submission request. In some embodiments, the data submission request may include at least one of a time range or a geographical range pertaining to an event which a source of the data submission request collects data relating to. Processing may continue from block 620 to block 630.

At block 630 (Determine that Data Corresponding to Information of Data Submission Request is Stored in Memory of Electronic Device), determination unit 340 may determine whether data corresponding to the data submission request obtained by decoder 330 is stored in memory 320. Processing may continue from block 630 to block 640.

At block 640 (Notify User of Electronic device of Data Submission Request), notification unit 350 may notify the user that the data corresponding to information of the data submission request is stored in memory 320. In some embodiments, electronic device 300 may include a speaker playing a sound to instruct the user of electronic device 300 to transmit the data in accordance with the data submission request. In another embodiment, alternatively or additionally, electronic device 300 may include a display configured to display a message to instruct user 100 to transmit the data in accordance with the data submission request.

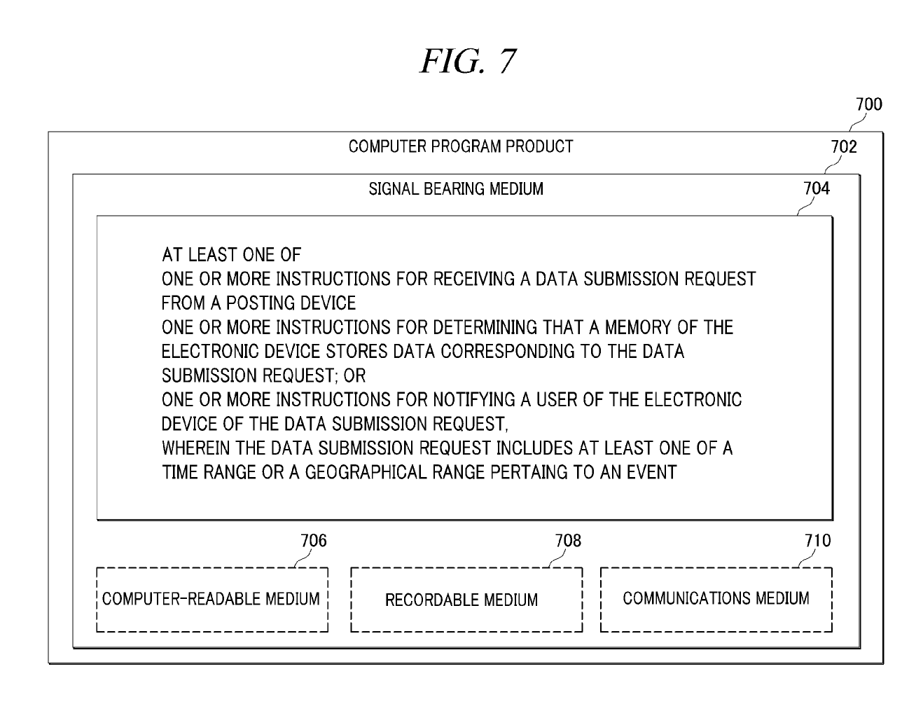

FIG. 7 illustrates an example computer program product that may be utilized to implement at least portions of a data collection scheme, arranged in accordance with at least some embodiments described herein. Program product 700 may include a signal bearing medium 702. Signal bearing medium 702 may include one or more instructions 704 that, when executed by, for example, a processor, may provide the functionality described above with respect to FIGS. 1 to 6. By way of example, instructions 704 may include: one or more instructions for receiving a data submission request from a posting device; one or more instructions for determining that a memory of the electronic device stores data corresponding to the data submission request; or one or more instructions for notifying a user of the electronic device of the data submission request, wherein the data submission request includes at least one of a time range or a geographical range pertaining to an event. Thus, for example, referring to FIG. 3, electronic device 300 may undertake one or more of the blocks shown in FIG. 6 in response to instructions 704.

In some implementations, signal bearing medium 702 may encompass a computer-readable medium 706, such as, but not limited to, a hard disk drive, a Compact Disc (CD), a Digital Versatile Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, program product 700 may be conveyed to electronic device 300 by an RF signal bearing medium 702, where the signal bearing medium 702 is conveyed by a wireless communications medium 710 (e.g., a wireless communications medium conforming with the IEEE 802.11 standard).

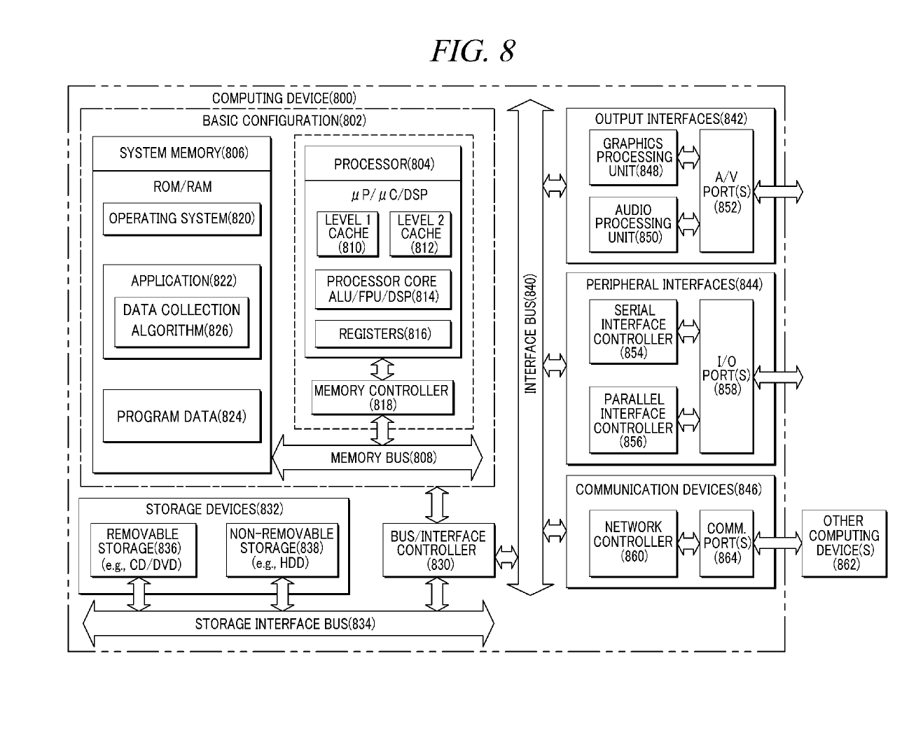

FIG. 8 shows a schematic block diagram illustrating an example computing system that can be utilized to implement at least portions of a data collection scheme, arranged in accordance with at least some embodiments described herein. In one example basic configuration 802, computing device 800 may include one or more processors 804 and a system memory 806. A memory bus 808 can be used for communicating between the processor 804 and the system memory 806.

Depending on the desired configuration, processor 804 may be of any type including but not limited to a microprocessor (μP), a microcontroller (μC), a digital signal processor (DSP), or any combination thereof. Processor 804 can include one or more levels of caching, such as a level one cache 810 and a level two cache 812, a processor core 814, and registers 816. Processor core 814 can include an arithmetic logic unit (ALU), a floating point unit (FPU), a digital signal processing core (DSP Core), or any combination thereof. A memory controller 818 can also be used with processor 804, or in some implementations memory controller 818 can be an internal part of processor 804.

Depending on the desired configuration, the system memory 806 may be of any type including but not limited to volatile memory (such as RAM), non-volatile memory (such as ROM, flash memory, etc.) or any combination thereof. System memory 806 may include an operating system 820, one or more applications 822, and program data 824. Application 822 may include data collection algorithm 826 that can be arranged to perform the functions, actions, and/or operations as described herein including the functional blocks, actions, and/or operations described with respect to process 600 of FIG. 6. In some example embodiments, application 822 may be arranged to operate with program data 824 on an operating system 820 such that implementations of data submission request processing may be provided as described herein.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 806, removable storage 836 and non-removable storage 838 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of device 800.

Computing device 800 may also include an interface bus 840 for facilitating communication from various interface devices (e.g., output interfaces, peripheral interfaces, and communication interfaces) to basic configuration 802 via bus/interface controller 830. Example output interfaces 842 may include a graphics processing unit 848 and an audio processing unit 850, which may be configured to communicate to various external devices such as a display or speakers via one or more A/V ports 852. Example peripheral interfaces 844 may include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication interface 846 includes a network controller 860, which may be arranged to facilitate communications with one or more other computing devices 862 over a network communication via one or more communication ports 864. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 800 may also be implemented as a personal computer including both laptop computer and non-laptop computer configurations. In addition, computing device 800 may be implemented as part of a wireless base station or other wireless system or device.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected,” or “operably coupled,” to each other to achieve the desired functionality, and any two components capable of being so associated may also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” and the like include the number recited and refer to ranges which may be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of an electronic device, the method comprising:
receiving a data submission request from a posting device;
determining that data corresponding to the data submission request is stored in a memory of the electronic device; and
notifying a user of the electronic device of the data submission request.

2. The method of claim 1, wherein the data submission request includes at least one of a time range or a geographical range pertaining to an event.

3. The method of claim 2, wherein the data submission request is included in a code that is displayed by the posting device.

4. The method of claim 3, wherein the code is a QR code.

5. The method of claim 3, wherein the receiving includes capturing the code by a camera of the electronic device.

6. The method of claim 5, further comprising:
decoding the code to obtain the at least one of the time range or the geographical range, and
wherein the determining includes searching the memory of the electronic device for data based at least in part on the at least one of the time range or the geographical range.

7. The method of claim 2, wherein the data submission request is included in a radio signal that is transmitted from the posting device,
wherein the receiving includes receiving the radio signal and deciphering at least one of the time range or the geographical range, and
wherein the determining includes searching the memory of the electronic device for data based at least in part on the at least one of the time range or the geographical range.

8. The method of claim 2, wherein the data submission request is included in an optical tag that is displayed by the posting device,
wherein the receiving includes capturing the optical tag by an optical tag reader of the electronic device and deciphering the at least one of the time range or the geographical range, and
wherein the determining includes searching the memory of the electronic device for data based at least in part on the at least one of the time range or the geographical range.

9. The method of claim 1, wherein the notifying includes displaying, by a display of the electronic device, a message to instruct the user of the electronic device to transmit the data to a source of the data submission request.

10. The method of claim 1, wherein the notifying includes playing, by a speaker of the electronic device, a sound to instruct the user of the electronic device to transmit the data to a source of the data submission request.

11. The method of claim 1, wherein the data includes at least one of a digital image or a video.

12. The method of claim 1, further comprising:
transmitting the data to a source of the data submission request.

13. An electronic device, comprising:
a camera configured to capture a data submission request displayed by a posting device;
a memory configured to store one or more images or videos captured by the camera;
a determination unit configured to determine that the memory stores one or more images or videos corresponding to information included in the data submission request; and
a notification unit configured to notify a user of a positive result of the determining.

14. The electronic device of claim 13, wherein the data submission request includes at least one of a time range or a geographical range pertaining to an event.

15. The electronic device of claim 14, wherein the data submission request is displayed as a code.

16. The electronic device of claim 15, further comprising:
a decoder configured to decode the code to obtain the at least one of the time period or the geographical range,
wherein the determination unit is further configured to search the memory for the one or more images or videos corresponding to at least one of the time range or the geographical range.

17. The electronic device of claim 13, wherein the notification unit includes a display that is configured to display a message to instruct the user of the electronic device to transmit the one or more images or videos corresponding to the information included in the data submission request to a source of the data submission request.

18. The electronic device of claim 13, wherein the notification unit includes a speaker that is configured to play a sound to instruct the user of the electronic device to transmit the one or more images or videos corresponding to the information included in the data submission request to a source of the data submission request.

19. The electronic device of claim 13, further comprising:
a transmitter configured to transmit the one or more images or videos corresponding to the information included in the data submission request to a source of the data submission request.

20. A non-transitory computer-readable storage medium having stored thereon computer-executable instructions that, in response to execution, cause an electronic device to perform operations, comprising:
receiving a data submission request from a posting device;
determining that a memory of the electronic device stores data corresponding to the data submission request; and
notifying a user of the electronic device of the data submission request,
wherein the data submission request includes at least one of a time range or a geographical range relevant to an event.
